(19) United States
(12) Patent Application Publication
(10) Pub. No.: US 2013/0169020 A1
(43) Pub. Date: Jul. 4, 2013

(54) ERGONOMIC SEAT ARRANGEMENT FOR MILITARY AND OTHER VEHICLES

(71) Applicants: Dan Raz, Haifa (IL); Zeev Geva, Kiryat Ata (IL)

(72) Inventors: Dan Raz, Haifa (IL); Zeev Geva, Kiryat Ata (IL)

(21) Appl. No.: 13/820,521

(22) PCT Filed: Sep. 15, 2011
(86) PCT No.: PCT/IL11/00736

§ 371 Date: Mar. 4, 2013

Related U.S. Application Data
(60) Provisional application No. 61/383,359, filed on Sep. 16, 2010.

(51) Int. Cl. B60N 2/24

(52) U.S. Cl. CPC B60N 2/24
USPC 297/440.15

(57) ABSTRACT

A seating system for supporting a user in a seated position employs a worn article (10), such as a tactical vest or a backpack, carried on the torso of the user (12). An anchoring system is deployed in defined spatial relation to a lower seat support (16). The anchoring system and the worn article have complementary connecting portions (20) selectively interconnectable to anchor the worn article (10) relative to the lower seat support (16) so that the lower seat support and the worn article together define a seat for supporting the user in a seated position with a region (14) of the worn article providing a back rest. The complementary connecting portions are disconnectable to allow the user to move freely with the worn article remaining on the torso of the user.

### FIELD AND BACKGROUND OF THE INVENTION

The present invention relates to an ergonomic seat arrangement for users carrying body-mounted equipment, and particularly suitable for use in military vehicles.

Soldiers are often required to carry a considerable amount of body-mounted equipment, typically in a backpack and/or hung directly on an article of clothing, such as a tactical vest, flak jacket, body armor or equipment belt. Under combat conditions, equipment may need to be remain mounted on the body continuously, ready for immediate use at all times. While traveling in a vehicle, this presents a severe problem in that the backpack or other equipment is interposed between the soldier and the backrest of a vehicle seat, preventing the wearer from leaning directly on the backrest and forcing a bent-forward position. Such a position is uncomfortable, puts the soldier in an offset position on the seat and, if maintained for longer periods, may give rise to muscular cramps or fatigue, unnecessarily adding to the physical and mental stress of the combat situation. Additionally, military vehicle seats are often designed to provide blast shock-absorbing properties, but such properties are optimized for a person sitting in a “normal” sitting position centrally within the seat, and may have significantly reduced efficacy when the user is sitting in a bent-forward position as described above.

### SUMMARY OF THE INVENTION

According to an embodiment of the present invention, there is provided a seat arrangement in which an article worn by a user, for example, in the form of a specially modified vest or other garment or backpack, can be temporarily anchored to a complementary device mounted in a vehicle so that the article itself becomes a functional part of the seat arrangement.

In one particularly preferred embodiment, an anchoring arrangement applies tension to at least a portion of the worn article extending behind the body of the user so that the worn article serves as a back rest of the seat arrangement. In this case, no fixed seat back is typically provided. Instead, a support, for example formed from two upright bars, is typically provided in order to give sufficient support for the anchoring arrangement. Alternatively, the entire anchoring arrangement may be provided by an arrangement of light-weight straps without any solid upright supports.

Thus, according to the teachings of an embodiment of the present invention there is provided, a seating system for supporting a user in a seated position, the system comprising: (a) a worn article including a back support region, the worn article being configured to be carried on the torso of the user with the back support region adjacent to the back of the user; (b) a lower seat support; and (c) an anchoring system deployed in defined spatial relation to the lower seat support, wherein the anchoring system and the worn article have complementary connecting portions selectively interconnectable to anchor the worn article relative to the lower seat support such that the lower seat support and the back support region together define a seat configuration for supporting the user in a seated position with the back support region providing a back rest, and wherein the complementary connecting portions are disconnectable to allow the user to move freely with the worn article carried on the torso of the user.

According to a further feature of an embodiment of the present invention, the worn article is a backpack.

According to a further feature of an embodiment of the present invention, the worn article is a garment.

According to a further feature of an embodiment of the present invention, the garment is a load-carrying garment.

According to a further feature of an embodiment of the present invention, the lower seat support and the anchoring system are deployed within a passenger compartment of a vehicle.

According to a further feature of an embodiment of the present invention, the lower seat support is suspended within a passenger compartment of a vehicle by an arrangement of straps.

According to a further feature of an embodiment of the present invention, the anchoring system comprises a pair of elongated upright support elements, and wherein interconnection of the complementary connecting portions suspends the back support region between the pair of elongated upright support elements.

According to a further feature of an embodiment of the present invention, the elongated upright support elements and the lower seat support are rigidly interconnected to form a open-back seat unit.

According to a further feature of an embodiment of the present invention, there is also provided a detachable backrest configured for temporary attachment between the elongated upright support elements to allow use of the seating system by a person not having the worn article.

According to a further feature of an embodiment of the present invention, there is also provided at least one tightening mechanism deployed to selectively increase tension applied to the back support region between the complementary connecting portions.

According to a further feature of an embodiment of the present invention, there is also provided a release mechanism for simultaneously releasing interconnection of a plurality of the complementary connecting portions.

According to a further feature of an embodiment of the present invention, the complementary connecting portions include a plurality of anchoring straps integrated into the worn article, and wherein each of the anchoring straps is mounted retractably so as to be biased to retract to a position at least partially withdrawn into a recess in the worn article.

There is also provided, according to an embodiment of the present invention, a method for supporting a user in a seated position, the method comprising the steps of: (a) deploying on a user a worn article including a back support region, the worn article being carried on the torso of the user with the back support region adjacent to the back of the user; and (b) releasably anchoring the worn article to a support structure so that the back support region is supported in a position to provide at least part of a seat configuration for supporting the user in a seated position with the back support region providing a back rest.

According to a further feature of an embodiment of the present invention, the worn article is releasably anchored to an open frame forming part of an open-back seat unit.

According to a further feature of an embodiment of the present invention, a tightening mechanism is operated to apply tension to at least the back support region of the worn article.

According to a further feature of an embodiment of the present invention, a release mechanism is operated to simultaneously release a plurality of anchoring locations at which the worn article is anchored.

### BRIEF DESCRIPTION OF THE DRAWINGS

The invention is herein described, by way of example only, with reference to the accompanying drawings, wherein:

FIG. 1 is a schematic isometric view of an open-back seat unit for use as part of a seating system, constructed and operative according to an embodiment of the present invention;

FIG. 2 is a schematic rear isometric view illustrating a seating system, constructed and operative according to an embodiment of the present invention, employing the open-back seat unit of FIG. 1 together with a specially adapted tactical vest worn by a user;

FIG. 3 is a schematic rear isometric view similar to FIG. 2 employing a backpack worn by a user;

FIG. 4 is a schematic isometric view illustrating a first implementation of a tactical vest including suspension straps and a safety restraint strap integrated with the vest;

FIGS. 5A and 5B are schematic isometric views illustrating a second implementation of a tactical vest including suspension straps;

FIG. 5C is a schematic enlarged region from a tactical vest illustrating a self-retracting strap arrangement;

FIG. 6 is a schematic side view illustrating a possible configuration for deployment of straps relative to a tactical vest;

FIG. 7 is a schematic isometric view illustrating a further possible configuration for deployment of straps relative to a tactical vest;

FIG. 8 is a schematic rear isometric view illustrating the use of the open-back chair unit of FIG. 1 with a detachable backrest to allow use of the seating system by a person without a specially adapted garment;

FIG. 9 is a schematic isometric view illustrating the structure of a head support according to a further aspect of the present invention, useful in combination as part of the seating system;

FIGS. 10A and 10B are schematic front and rear isometric views, respectively, of an implementation of the invention illustrative of an exemplary tightening and quick release mechanism;

FIG. 11A is a view similar to FIG. 10A with the user not present;

FIG. 11B is a view similar to 11A with parts of a lower seat support removed to reveal additional features of a tightening mechanism;

FIG. 12 is an enlarged isometric view of a remotely releasable clip from the implementation of FIGS. 10A and 10B; and

FIG. 13 is an enlarged view of the region of FIG. 10B designated XIII.

### DESCRIPTION OF THE PREFERRED EMBODIMENTS

The present invention is a seating system and corresponding method for supporting a user in a seated position, particularly useful for users carrying body-mounted equipment.

The principles and operation of systems and methods according to the present invention may be better understood with reference to the drawings and the accompanying description.

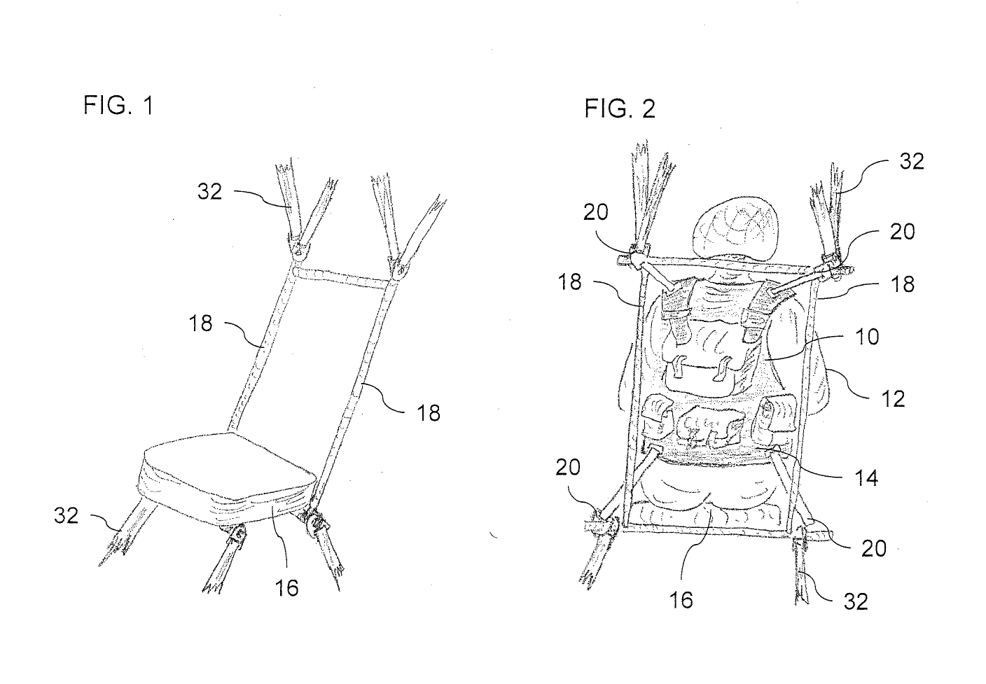

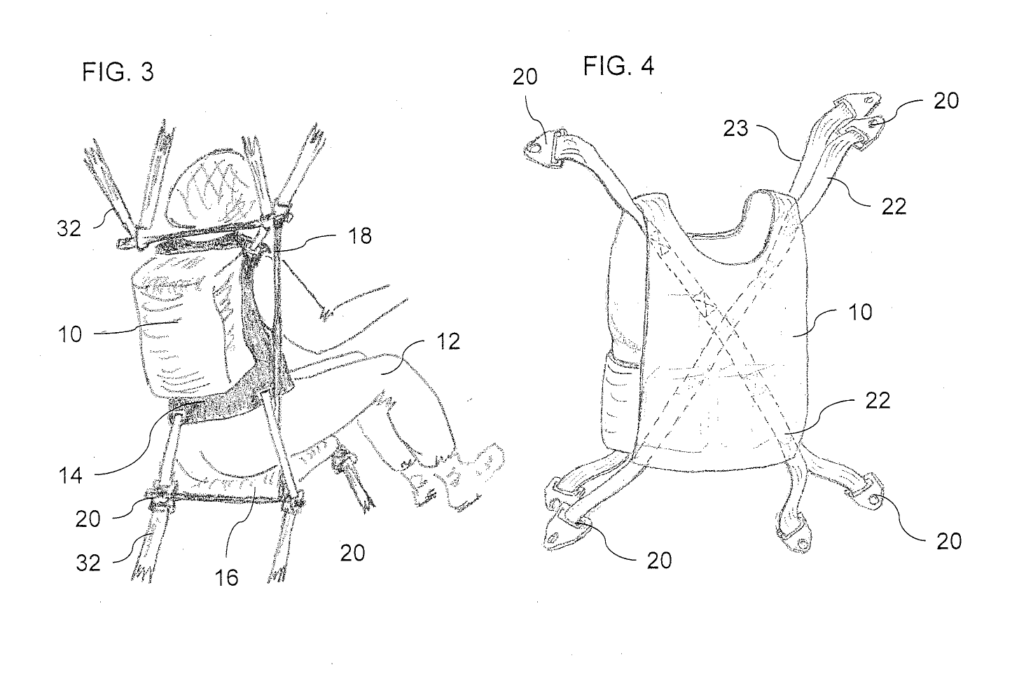

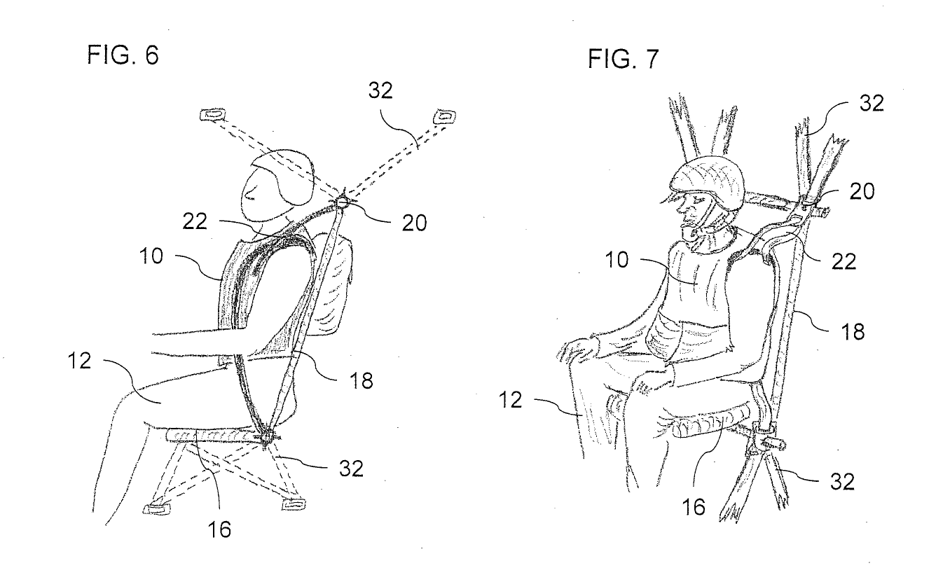

Referring now to the drawings, FIGS. 1-13 illustrate various features and implementations of a seating system for supporting a user in a seated position. Generally speaking, the system includes a worn article 10 configured to be carried on the torso of the user 12 with a back support region 14 adjacent to the back of the user. Non-limiting examples of worn article 10 are a garment, as illustrated in FIG. 2, and a backpack, as illustrated in FIG. 3.

The seating system also includes a lower seat support 16 and an anchoring system deployed in defined spatial relation to the lower seat support. In the exemplary embodiments illustrated here, the anchoring system includes an upper frame including a pair of spaced-apart upright elements 18, as best seen in FIG. 1. The anchoring system and the worn article 10 have complementary connecting portions 20 selectively interconnectable to anchor the worn article relative to lower seat support 16 such that lower seat support 16 and back support region 14 together define a seat configuration for supporting the user in a seated position with the back support region providing a back rest. When not in use, the complementary connecting portions 20 are disconnectable to allow user 12 to move freely with the worn article 10 carried on his or her torso.

At this stage, it will immediately be appreciated that, by employing part of a garment to provide the seat back, the aforementioned problems of body-mounted equipment interfering with the sitting position are avoided. Specifically, since the body-mounted equipment is hung on the outside of the garment, any equipment on the back of the user is located behind the layer(s) of material forming the effective back rest, and therefore does not interfere with the sitting position. Where upright seat-back supports are provided, these are located at the sides of the seat arrangement to allow any body-mounted equipment located to the rear of the user to pass between the supports. Furthermore, the body position of the user corresponds to the position for which the seat was designed, thereby conferring to the user any blast shock absorbing properties with which the seat was designed.

It should be noted that the absence of a fixed backrest to the seats provides additional advantages of ease of access to the internal space of the vehicle when the occupants are not seated.

Most preferably, the anchoring arrangement also provides vertical support sufficient to at least partially support the weight of body-mounted equipment hung directly or indirectly from the garment, thereby temporarily relieving the user from at least part of the weight of his load.

In certain embodiments, lower seat support 16 is implemented as an otherwise conventional horizontal seat cushion on which the user sits. In other embodiments, straps, a harness or some other suitably formed worn article may pass under the buttocks and/or between the legs of the user as part of, or in addition to, the garment on the upper body, and may provide complete seat-support functionality by attachment to the anchoring arrangement without any fixed horizontal cushion.

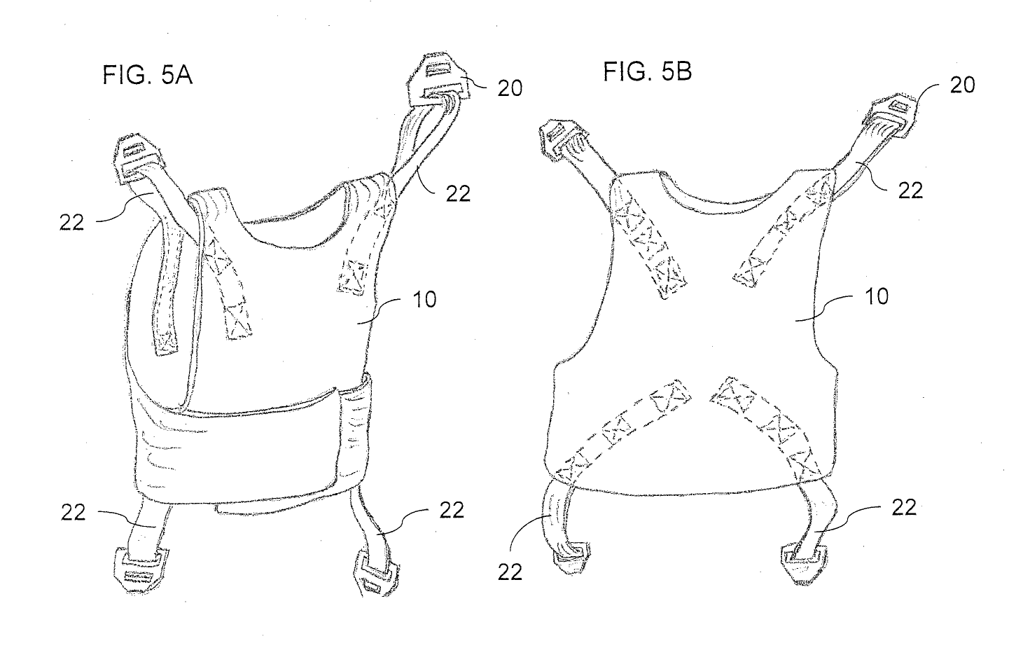

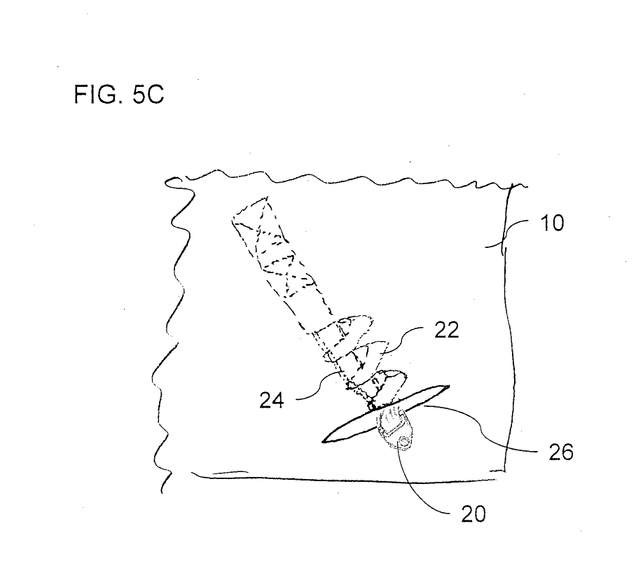

The anchoring arrangement typically includes at least four anchoring points, for example, two at the shoulders and two near the hips. It should be noted however that, depending on the nature of the worn article, in some cases, fewer anchoring points may be needed. For example, for a relatively rigid article, as few as two, or even one, anchoring point may in some cases be sufficient. For convenience and safety, connection of the anchoring points may advantageously be achieved using an arrangement of retractable straps, either mounted to the garment or to the vehicle-mounted support system, or both. According to one preferred embodiment illustrated schematically in FIG. 5C, the garment is provided with anchoring straps 22, themselves relatively inelastic when extended, but which are made self-retracting by attachment of elastic 24 which withdraws them into pouches 26 formed in the garment. These anchoring straps mate by suitable engagement to corresponding retractor mechanisms mounted to the vehicle-mounted support system. In one preferred implementation, the retractor mechanisms are initially at relatively low tension, allowing the user to conveniently draw out each garment anchoring strap in turn and to engage it with the corresponding retractor mechanism. After all the garment anchoring straps are connected, an actuator system of any suitable type (for example, manually operated or having electromagnetic actuators or motors) may be operated to draw tight the retractor mechanisms, thereby applying sufficient tension to the relevant part of the garment to provide the desired backrest function. Optionally, the actuator system may be individually adjustable to change the tension applied to the retractor mechanisms, thereby adjusting the “feel” of the backrest, for example, between “firm” and “soft”. Although the actuator-based system as described above is believed to be particular advantageous for ease of use, it should be noted that a fixed-tension implementation in which the user attaches the connections under sufficient tension to provide the backrest functionality also falls within the scope of this aspect of the invention.

In order to allow immediate release of the user, for example, for rapid evacuation of the vehicle, all of the anchoring points are preferably released by a single quick release mechanism that releases all of the catch mechanisms simultaneously. The garment anchoring straps then recoil into their pouches, thereby instantly freeing the user to leave his seat unimpeded.

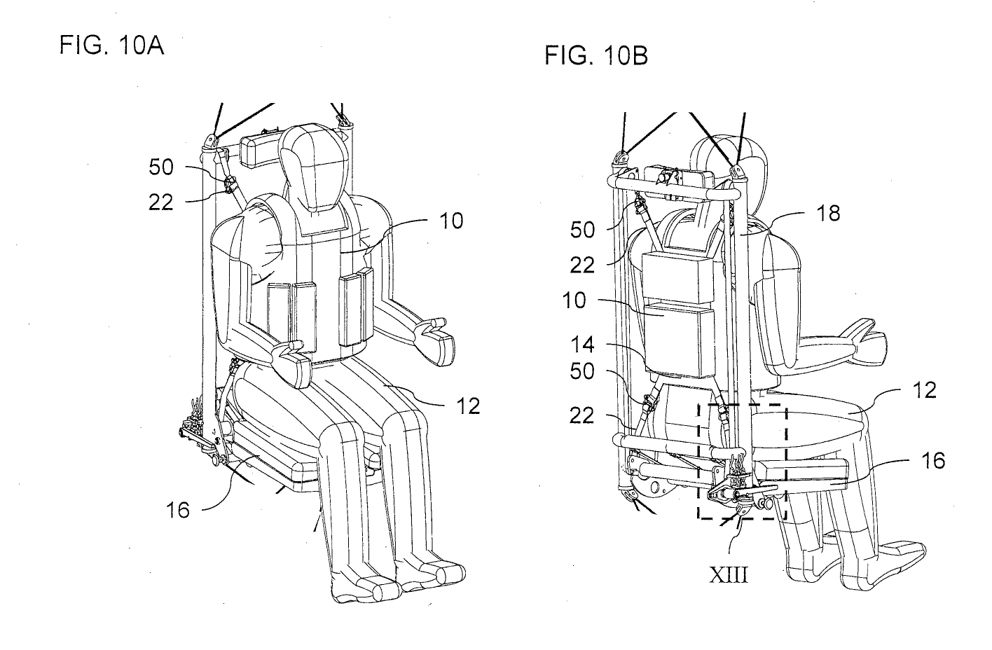

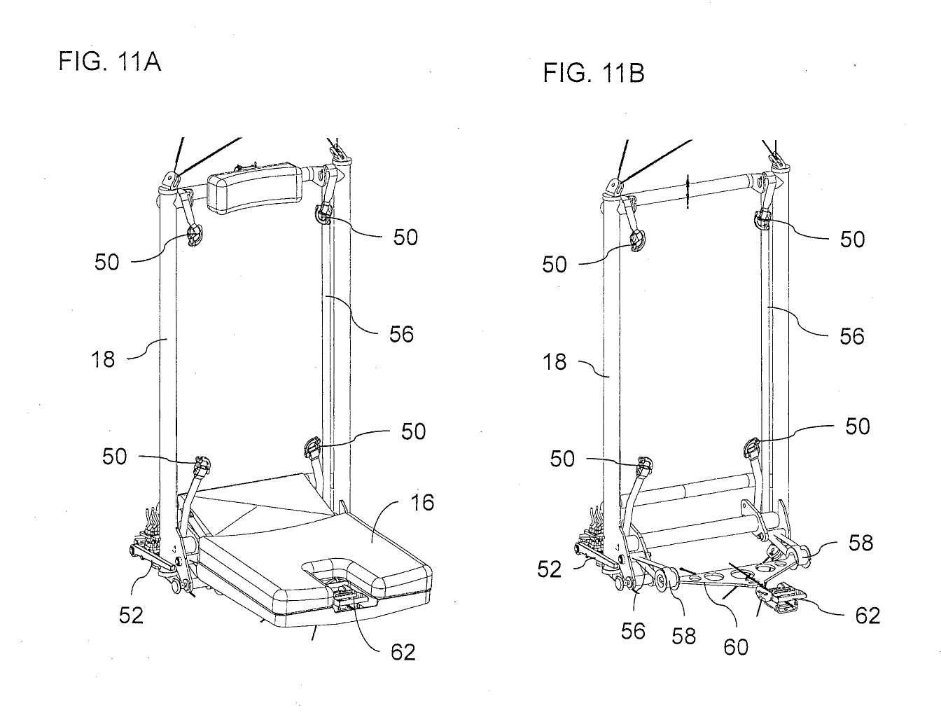

FIGS. 10A-13 illustrate a possible implementation of an arrangement for tightening the suspension arrangement, and for quick release of the interlocking arrangements to allow the user to leave the seat. FIGS. 10A and 10B give a general view of this implementation while in use FIG. 11A shows a view similar to FIG. 10A with the user not present, and FIG. 11B shows a similar view with parts of the lower seat support removed to reveal the tightening mechanism.

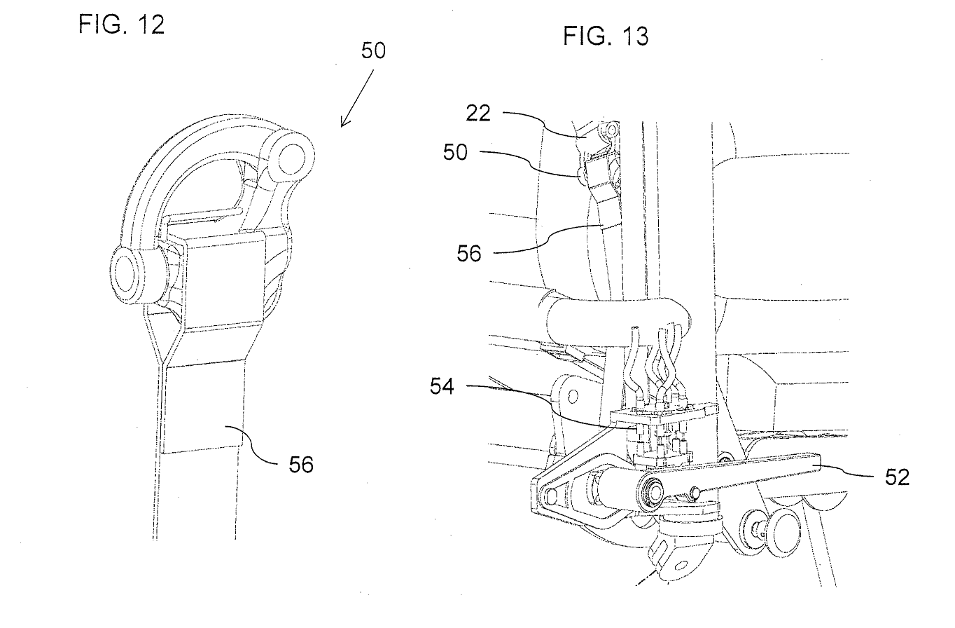

This implementation has two upper (shoulder) attachment points and two lower (hip) attachment points. Each attachment point is provided with a remote-release clip 50, shown in more detail in FIG. 12, which locks closed on a loop of strap from straps 22 of garment 10, and which is released by operating a lever 52 (FIG. 13) which pulls a number of cable release connections 54 (shown in part) to retract a spring-biased lock pin in each of clips 50.

Referring specifically to FIG. 11B, the upper and lower clips 50 on each side are permanently mounted on a common anchor strap 56 which passes around various rollers and under the seat to a pair of tensioning rollers 58 mounted on a bracket 60 which is displaceable forward by operation of a strap tightening mechanism 62 located at the front of the lower seat support.

In use, the user connects all four clips 50 to the corresponding loops in straps 22 of his garment (or backpack etc.) 10 while the anchor straps are loose, and then operates tightening mechanism 62 which draws forward bracket 60, simultaneously taking up any slack and tightening left and right anchor straps 56, and hence all four attachment points so as to apply tension to the garment 10 and provide the effective back support.

When the user wishes to leave the seat, operation of lever 52 simultaneously releases all of clips 50, allowing the user to move away freely.

The garment employed as part of the seat arrangement may be any type of garment that can be worn by the user without hampering his normal functioning. Most preferably, the garment is a tactical garment of a type typically used to support body-mounted equipment (referred to generically herein as “load carrying equipment” or “LCE”, and including various holsters, pouches, loops or the like referred to generically as “equipment attachment features”), modified where necessary such as by provision of additional reinforced strips to take load in the directions applied by the present invention, and by addition of connection configurations, such as the retractable garment anchoring straps mentioned above, or simple attachment rings or strap loops. Where reinforcing strips are provided, they may be diagonal, horizontal, or vertical, or may include interconnected strips of different orientations to for in a network of reinforcing strips. In certain cases, it may be preferred to implement garment 10 with a number of continuous anchoring straps 22 extending through the garment, such as is illustrated in FIG. 4, thereby minimizing the loads applied directly to the fabric of the garment. Alternatively, as illustrated in FIGS. 5A and 5B, anchoring straps 22 may be sewn or otherwise integrated into the garment which is made sufficiently strong to withstand the expected loads.

Examples of garments to which the present invention may be applied include, but are not limited to, a tactical vest, flak jacket, body armor, ballistic protection unit, LCE of all types, and an equipment belt, Alternatively, suitable mechanical support and connection configurations may be included within a dedicated undergarment (referred to here as a “girdle”) which can be worn beneath a conventional tactical garment. As a further option, preferably although not necessarily reserved as an emergency back-up option, retractor belts of the seat arrangement may be adapted, possibly temporarily, by addition of toothed clamps or the like which may be used to grip the cloth of a conventional unmodified tactical garment for use as part of the seating arrangement.

According to certain embodiments of the present invention, the garment may additionally, or alternatively, provide the function of a safety restraint system, e.g., to arrest forward motion of the user in the event of a collision. In the example of FIG. 4, the safety restraint function is provided by an additional diagonally placed restraint strap 23 integrated with the garment so as to pass in front of the user. In the more preferred option illustrated in FIGS. 5A and 5B, the safety restraint function is provided through the same anchoring connections described above for the seat-back portion of the garment, together with suitable reinforced features of the garment. Alternatively, or in a case where the safety restraint functionality is needed to supplement a seat which has a conventional backrest, a dedicated safety-restraint anchoring arrangement may be provided. In the latter case, the garment may not need to be maintained in a pre-tensioned state.

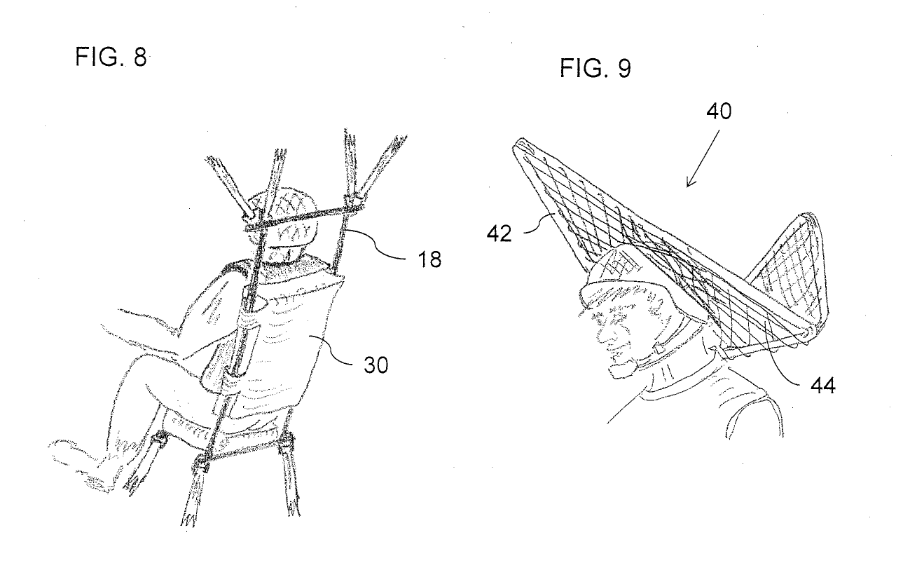

According to an embodiment of the invention, a seat arrangement of the aforementioned type which does not include a fixed backrest may be provided with a modular seat conversion cushion 30 which can be mounted on the support arrangement to facilitate use of the seat by a person without a suitable tactical garment as illustrated in. FIG. 8. Optionally, cushion 30 may be part of a built-in backrest which can be folded back and downwards in order to allow use of the seat alternatively as a conventional seat or without the conventional backrest.

According to a particularly preferred subset of embodiments of the invention as illustrated here in the drawings, the seat arrangement is suspended between the ceiling and floor of the vehicle by an arrangement of straps 32. Such arrangements for suspended seats are known in the art, particularly for use in military vehicles, and will not be described further herein. It will be noted, however, that the present invention is equally applicable to seats mounted to the floor of a vehicle in a conventional manner, or mounted in any other way.

Optionally in the case of a suspended seat, the suspension points of the seat assembly may be displaceable, for example along tracks in the ceiling and floor, to allow compact storage of the seating arrangements to make available the internal volume of the passenger compartment of the vehicle. It will be appreciated that the compact nature of the seat support arrangements, without backrest cushions, allows much more compact storage of the seating arrangements than would be possible for an array of conventional seats.

Clearly, it will be appreciated that the invention is not limited to floor-to-ceiling suspended seat arrangements, and may be implemented in any case where the relevant garment is anchored directly or indirectly to a support system associated with the vehicle. Thus, the invention may be implemented in a seat mounted on the floor of a vehicle (not shown) in an otherwise conventional manner. Furthermore, it will be appreciated that the invention is not limited to vehicle-mounted seats, and may be used in any situation in which a person carrying body-mounted equipment needs to be seated while at least part of their equipment needs to remain on their body. Where a horizontal seat cushion is provided, the support system need not be directly mechanically linked with the structure that supports the horizontal seat cushion.

It should be noted that an embodiment of the present invention may be implemented as a retrofit adaptation to a conventional vehicle seat, for example by replacing the conventional seat backrest with a frame according to the present invention, or by adding a frame around a backrest, the backrest itself being deployable between an active and a folded-back out-of-use state. Furthermore, in an embodiment of the invention, the principles of the invention may be implemented in a modular system which can be used by engaging elements of a conventional seat and seatbelt restraint system. Thus, the regular seatbelt may be used to anchor a system according to the present invention relative to a conventional seat.

Parenthetically, the term “horizontal” or “lower seat support” is used herein to refer to the surface or cushion upon which a person typically places the majority of his weight while sitting, in contrast to the more upright backrest, but should not be taken to imply any requirement for specifically horizontal deployment of the cushion. The term “upright” is used to refer to orientations suitable for use as a backrest, typically defined as within 30 degrees of the local vertical.

Optionally, to supplement the support to the torso provided by the present invention, certain embodiments may also provide a degree of support to the head of the user, typically by providing a flexible canopy 40, preferably formed by netting, above the user's head against which the user's helmet presses. This provides temporary support to the user's head position while at the same time satisfying safety requirements for ease of disengagement of the head from any support structure. A preferred example of such a structure, formed with a frame 42 above the head and netting 44 stretched across the frame, is shown in FIG. 9. Frame 42 is deployed sloping upwards in the forward directly, and in the implementation shown here, has a generally triangular shape. Optionally, additional support may be provided by appropriate positioning of complementary patches of VELCRO® fastener material on the user's helmet and on the canopy.

It will be appreciated that the above descriptions are intended only to serve as examples, and that many other embodiments are possible within the scope of the present invention as defined in the appended claims.

What is claimed is:

1. A seating system for supporting a user in a seated position, the system comprising:
(a) a worn article including a back support region, said worn article being configured to be carried on the torso of the user with said back support region adjacent to the back of the user;
(b) a lower seat support; and
(c) an anchoring system deployed in defined spatial relation to said lower seat support,
wherein said anchoring system and said worn article have complementary connecting portions selectively interconnectable to anchor said worn article relative to said lower seat support such that said lower seat support and said back support region together define a seat configuration for supporting the user in a seated position with said back support region providing a back rest, and wherein said complementary connecting portions are disconnectable to allow the user to move freely with said worn article carried on the torso of the user.

2. The seating system of claim 1, wherein said worn article is a backpack.

3. The seating system of claim 1, wherein said worn article is a garment.

4. The seating system of claim 3, wherein said garment is a load-carrying garment.

5. The seating system of claim 1, wherein said lower seat support and said anchoring system are deployed within a passenger compartment of a vehicle.

6. The seating system of claim 1, wherein said lower seat support is suspended within a passenger compartment of a vehicle by an arrangement of straps.

7. The seating system of claim 1, wherein said anchoring system comprises a pair of elongated upright support elements, and wherein interconnection of said complementary connecting portions suspends said back support region between said pair of elongated upright support elements.

8. The seating system of claim 7, wherein said elongated upright support elements and said lower seat support are rigidly interconnected to form a open-back seat unit.

9. The seating system of claim 8, further comprising a detachable backrest configured for temporary attachment between said elongated upright support elements to allow use of said seating system by a person not having said worn article.

10. The seating system of claim 1, further comprising at least one tightening mechanism deployed to selectively increase tension applied to said back support region between said complementary connecting portions.

11. The seating system of claim 1, further comprising a release mechanism for simultaneously releasing interconnection of a plurality of said complementary connecting portions.

12. The seating system of claim 1, wherein said complementary connecting portions include a plurality of anchoring straps integrated into said worn article, and wherein each of said anchoring straps is mounted retractably so as to be biased to retract to a position at least partially withdrawn into a recess in said worn article.

13. A method for supporting a user in a seated position, the method comprising the steps of:
(a) deploying on a user a worn article including a back support region, said worn article being carried on the torso of the user with said back support region adjacent to the back of the user; and
(b) releasably anchoring said worn article to a support structure so that said back support region is supported in a position to provide at least part of a seat configuration for supporting the user in a seated position with said back support region providing a back rest.

14. The method of claim 13, wherein said worn article is releasably anchored to an open frame forming part of an open-back seat unit.

15. The method of claim 13, further comprising operating a tightening mechanism to apply tension to at least the back support region of the worn article.

16. The method of claim 13, further comprising operating a release mechanism to simultaneously release a plurality of anchoring locations at which the worn article is anchored.

17. The method of claim 13, wherein said worn article is a backpack.

18. The method of claim 13, wherein said worn article is a garment.

19. The method of claim 18, wherein said garment is a load-carrying garment.
